(19) United States
(12) Patent Application Publication
(10) Pub. No.: US 2009/0225740 A1
(43) Pub. Date: Sep. 10, 2009

(54) MULTI-BEAM TRANSMITTING AND RECEIVING APPARATUS

(76) Inventors: Bon Jun Ku, Daejeon (KR); Do-Seob Ahn, Daejeon (KR)

Correspondence Address: STAAS & HALSEY LLP, SUITE 700, 1201 NEW YORK AVENUE, N.W., WASHINGTON, DC, 20005, US

(21) Appl. No.: 12/307,202

(22) PCT Filed: Dec. 29, 2006
(86) PCT No.: PCT/KR06/05883

§ 371 Date: Dec. 31, 2008

(30) Foreign Application Priority Data
Aug. 8, 2006 (KR) 10-2006-0074664

(51) Int. Cl. H04J 3/00

(52) U.S. Cl. 370/345

(57) ABSTRACT

A multi-beam transmitting and receiving apparatus in a wireless communication system includes a plurality of transmitting beam forming units for forming timely-divided multiple beams, each of the timely-divided multiple beams having a period of a total number of time division NTD at every time TD when the beams are activated; and a beam controller for controlling the transmitting beam forming units to select an arbitrary beam forming unit of a plurality of the transmitting beam forming units according to information about the time division, wherein the number of the beam forming units is determined as the total number of the beams NBM divided by the number of time division NTD.

### TECHNICAL FIELD

The present invention relates to a multi-beam forming apparatus for use in a wireless communication system; and, more particularly, to a multi-beam transmitting and receiving apparatus which is capable of efficiently forming multiple beams and performing transmission/reception by using the multiple beams.

### BACKGROUND ART

Nowadays, a wireless communication system provides a wireless communication service such as a ground based wireless communication, a satellite communication, a stratospheric communication and the like, and forms a large number of multiple beams to provide sufficient link margin to subscribers in a wide service area. Especially, in case of the satellite communication and the stratospheric communication, a signal loss due to a distance from the subscribers on the ground to a satellite or stratospheric communications payload is high, so that the necessity of the multiple beams is more important.

When the multiple beams are implemented interference between numerous adjacent beams each of which has the same frequency band is generated to cause deterioration of communication quality. Therefore, the multiple beams are generally implemented through frequency reuse by uniformly dividing the frequency band in order to mitigate the interference.

For example, in case of the stratospheric wireless communication system, since each 300 MHz bandwidth in a 48/47 GHz band was allocated for the stratospheric communication, application scenarios using the bandwidth have been suggested. A stratospheric platform can provide high-speed multimedia services to a service area of 1,000 km in diameter. While a plurality of platforms are installed in order to expand the service area even more, the used frequency bandwidth 300 MHz is divided by a frequency reuse rate of 3:1 to avoid interference among the communication frequency bands of the platforms. In other words, each platform uses a different bandwidth of 100 MHz.

Further, in order to prevent deterioration phenomena of the communication quality which may occur as a distance between the subscribers and the platform becomes longer by approaching from a position below the stratospheric platform to a periphery of the service area, the entire service area is divided into a city area, a suburb area and a rural area. Further, a power and an antenna gain are determined for each area to provide sufficient services thereto. Multiple beams up to 700 beams are implemented and then arranged at a frequency reuse rate of 7:1 for each area. Therefore, one platform can provide 2,100 beams in total; and if a protective bandwidth is 23 MHz, a usable bandwidth for each beam becomes 11 MHz. Furthermore, dynamic allocation multiple access technique is applied thereto for the subscribers to efficiently use the frequency bandwidth. In order that one platform can provide 2,100 beams for transmission and reception to the service area of 1,000 Km in diameter, beam forming units corresponding to the number of the beams should be implemented; and a mechanical apparatus capable of digital beam forming and having 3 axes is used to control pointing positions of the multiple beams with regard to position change of the platform by the time.

On the other hand, the satellite wireless communication system includes a multi-beam transmitting and receiving apparatus using a geostationary satellite and a low earth orbit satellite; and further employs an adaptive digital beam forming unit to efficiently use a frequency bandwidth and to re-form the beams according to external environmental variation. Likewise, the multiple beams in this system are implemented by frequency-dividing the entire frequency band with an appropriate frequency reuse rate to minimize frequency interference among the beams. In case of satellites, since a payload weight is an important factor, the satellite wireless communication system has hundreds of beams as compared with stratospheric wireless communication system having thousands of beams.

As described above, according to the method for implementing multiple beams in the conventional wireless communication system, the beams are arranged by the frequency reuse rate in order to mitigate interference among the beams generated by using a frequency division method; and beam forming units corresponding to the number of the total beams are required.

Therefore, required beam forming units also increase if numerous multiple beams are implemented, which results in increasing the complexity of the multi-beam transmitting and receiving apparatus.

### DISCLOSURE OF INVENTION

### Technical Problem

It is, therefore, an object of the present invention to provide a multi-beam receiving apparatus and a multi-beam transmitting apparatus capable of reducing the complexity of the hardware by forming beam forming units less than total required beams and of reducing power consumption by forming receiving and transmitting beams of an adaptive type since multiple beams are formed by time-dividing each beam which has the entire frequency band.

### Technical Solution

In accordance with a preferred embodiment of the present invention, there is provided a multi-beam transmitting and receiving apparatus in a wireless communication system, the apparatus including a plurality of transmitting beam forming units for forming timely-divided multiple beams, each of the timely-divided multiple beams having a period of a total number of time division NTD at every time TD when the beams are activated; and a beam controller for controlling the transmitting beam forming units to select an arbitrary beam forming unit of a plurality of the transmitting beam forming units according to information about the time division, wherein the number of the beam forming units is determined as the total number of the beams NBM divided by the number of time division NTD.

### Advantageous Effects

The present invention forms a multi-beam using a beam forming method of performing time division on beams, so that it is possible to provide with beam forming units less than total required beams having the entire frequency band, thus reducing the complexity of the hardware therefor.

Furthermore, the present invention adaptively forms a transmission or reception beam, thus reducing power consumption.

### BRIEF DESCRIPTION OF THE DRAWINGS

The above and other objects and features of the present invention will become apparent from the following description of preferred embodiments given in conjunction with the accompanying drawings, in which:

FIG. 1 schematically shows a wireless communication system which provides transmitting and receiving services by using multiple beams in accordance with the present invention;

FIG. 2 is a configuration block diagram schematically showing a multi-beam receiving apparatus in accordance with the present invention;

FIG. 3 is a configuration block diagram schematically showing a multi-beam transmitting device in accordance with the present invention;

FIG. 4 is a configuration block diagram describing in detail a beam controller employed in a multi-beam transmitting and receiving apparatus in accordance with the present invention;

FIG. 5 presents a drawing for describing multiple beams formed by time-dividing the total beam number in the multi-beam transmitting and receiving apparatus in accordance with the present invention; and

FIG. 6 represents a drawing for describing timely-divided multiple beams of an adaptive-type formed in the multi-beam transmitting and receiving apparatus in accordance with the present invention.

### BEST MODE FOR CARRYING OUT THE INVENTION

Hereinafter, preferred embodiments of the present invention will be described in detail with reference to the accompanying drawings so that they can be readily implemented by those skilled in the art.

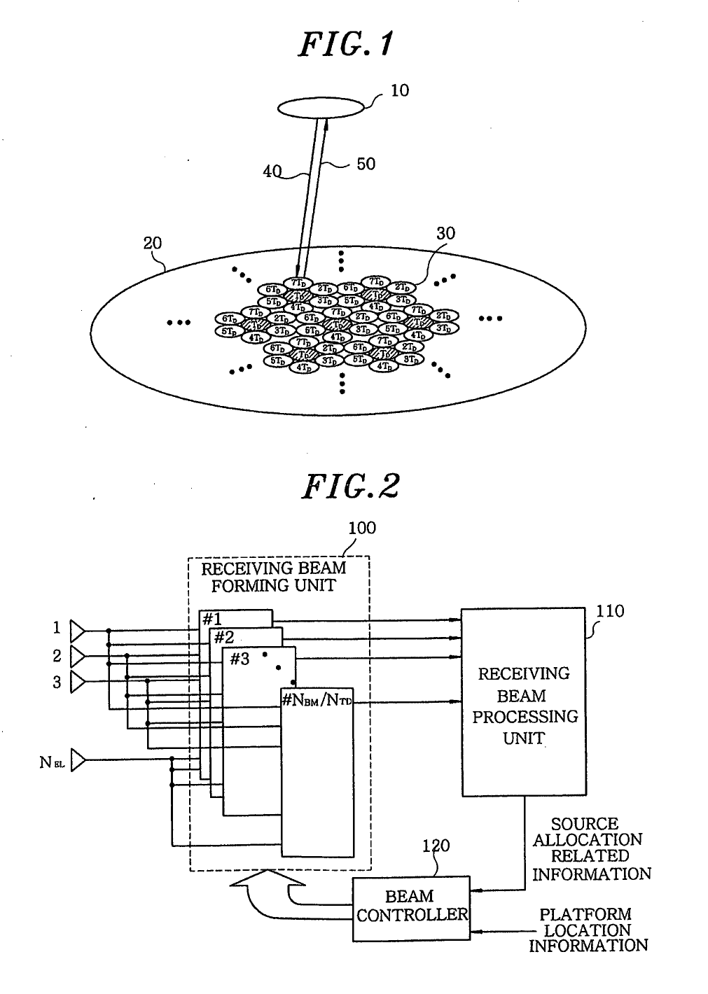

Referring to FIG. 1, there is schematically shown a wireless communication system which provides transmitting and receiving services by using multiple beams in accordance with the present invention. In this regard, it is noted that the following description of the present invention may be made to HAPS (High Altitude Platform Station) system wherein wireless communication is serviced using an airship or an air vehicle stayed in the air, however, it may also be applicable to any adaptive multiple beam formation of wireless communication system.

As shown in FIG. 1, the wireless communication system for providing the transmitting and receiving services of the multiple beams in accordance with the present invention includes a satellite (not shown) to relay signals, a transmitting and receiving apparatus 10 performing the same function as a platform or a base station, multiple beams or cells 30 distributed in a service area 20 where subscribers are distributed. In the wireless communication system, a transmitting beam 40 is radiated from the transmitting and receiving apparatus 10 to the subscribers in the service area 20 and a receiving beam 50 is received at the transmitting and receiving apparatus 10 from the subscribers in the service area 20.

In order to provide ultra-speed multimedia service having sufficient link margin to the subscribers distributed in the area 20, the transmitting beam 40 and the receiving beam 50 are formed by using multiple beams in the wireless communication system. Herein, instead of a method for implementing multiple beams by frequency-dividing the entire frequency band according to a conventional frequency reuse, a method for implementing multiple beams by time-dividing each beam which has the entire frequency band is devoted to the present invention.

In other words, the multiple beams by the time division method in the present invention are formed by time-dividing all multiple beams to have a predetermined time period. In case that the total number of the beams required in the service area 20 is indicated as NBM; and time when sub-multiple beams formed by time division are activated is indicated as TD; and the total number of the time division is indicated as NTD, by implementing a predetermined number (total beam number/NTD) of the sub-multiple beams at every time TD, all beams are formed with a period of NTD×TD. Accordingly, the number of sub-multiple beams activated during the time of TD becomes NBM/NTD. By repeating this NTD times, timely-divided beams corresponding to the total number are formed. Further, the sub-multiple beams being activated during TD are formed in such a manner that multiple beams are allocated to minimize a cochannel interference effect among the beams. For example, FIG. 1 shows a case where a total number of the time division is set to be 7; and the number of time division in the beam forming method can be extended to an arbitrary NTD (total number of time division).

Furthermore, in the multiple beams formed by the time division method of the present invention, in order to improve power and capacity efficiency, the receiving beam 50 and the transmitting beam 40 are formed as an adaptive type to an active or inactive state of the subscribers in the service area 20. First, in case of a simple scenario forming adaptive-type multiple beams, while multiple beams for the receiving beam 50 are divided by time TD to activate sub-multiple beams periodically, multiple beams for the transmitting beam 40 are implemented for the cells 30 where the subscribers are activated; but are not allocated to the cells 30 where the subscribers are not activated by detecting an activation state of the subscribers contained in the receiving beam 50. This method is composed of combination of receiving multiple beams by the time division method and transmitting multiple beams by the adaptive-type time division method.

As another scenario, both the receiving beam 50 and the transmitting beam 40 are generated as an adaptive type according to the activation state of the subscribers in the service area 20. More specifically, first, after detecting the activation state of the subscribers of the corresponding cell 30 through the receiving beam 50, if the subscribers of the cell 30 are in an active state, beams are periodically formed at a beam forming point of time for a next corresponding cell 30; and whereas if the subscribers are in the inactive state, beams are not formed at the beam forming point of time for the next corresponding cell 30, but instead, beams are formed at a next point of time after the beam forming time. That is, by increasing a beam forming period in the inactive state step by step until to a predetermined maximum beam forming period, power for forming the beams in the service area where the subscribers are in the inactive state can be reduced, and therefore, extra beams can be additionally allocated to other area.

FIG. 2 is a configuration block diagram schematically showing a receiving apparatus of the multi-beam transmitting and receiving apparatus in accordance with the present invention.

As shown in FIG. 2, the multi-beam receiving apparatus of the present invention includes a plurality of antennas 1, 2, 3 . . . NEL for receiving the beams, receiving beam forming units 100 for forming receiving beams, a receiving beam processing unit 110 for processing the receiving beams, a beam controller 120 for controlling the receiving beam forming units 100 on the basis of source allocation related information, i.e., time division information, of the receiving beam processing unit 110 and platform location information.

The multi-beam receiving apparatus of the present invention generates sub-multiple beams of a predetermined number NBM/NTD at every time TD in a time division method and receives all the multiple receiving beams through the receiving beam forming units 100 at a period of NTD×TD. The receiving beam forming units 100 have beam forming units of NBM/NTD, the total beam number NBM being divided by the total number of the time division NTD.

The beam controller 120 of the multi-beam receiving apparatus in the present invention selects an arbitrary beam forming unit of the receiving beam forming units 100 based on the source allocation related information such as the total beam number NBM required in the service area, the divided time TD and the total number of the time division NTD to form the receiving beams.

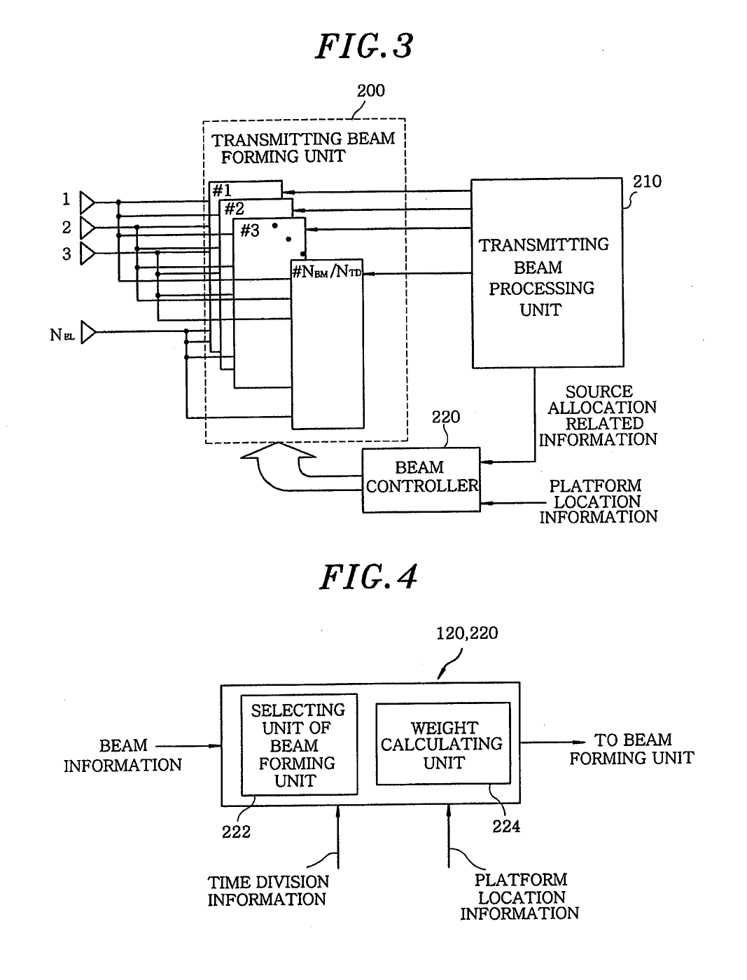

FIG. 3 is a configuration block diagram schematically showing a transmitting apparatus of the multi-beam transmitting and receiving apparatus in accordance with the present invention.

As described in FIG. 3, the multi-beam transmitting apparatus of the present invention includes a plurality of antennas 1, 2, 3 . . . NEL for transmitting the beams, transmitting beam forming units 200 for forming transmitting beams, a transmitting beam processing unit 210 for processing the transmitting beams, a beam controller 220 for controlling the transmitting beam forming units 200 on the basis of source allocation related information, i.e., time division information, of the transmitting beam processing unit 210 and platform location information.

The multi-beam transmitting apparatus of the present invention implements sub multiple beams of a predetermined number NBM/NTD at every time TD according to a time division method and transmits all the multiple transmitting beams through the transmitting beam forming units 200 at a period of NTD×TD. The transmitting beam forming units 200 have beam forming units of NBM/NTD, the total beam number NBM being divided by the total number of the time division NTD.

The beam controller 220 of the multi-beam transmitting device in the present invention selects an arbitrary beam forming unit of the transmitting beam forming units 200 based on the source allocation related information such as the total number NBM of the beam required in the service area, the divided time TD and the total number of the time division NTD to form the transmitting beams.

Accordingly, in the multi-beam transmitting and receiving apparatus according to the conventional frequency division method, beam forming units are needed to all the beams required in the transmitting and receiving apparatus, whereas in the multi-beam transmitting and receiving apparatus of tie present invention, the number of beam forming units can be reduced by a time division rate, the total beam number NBM divided by NTD.

FIG. 4 is a configuration block diagram describing in detail the beam controller employed in the multi-beam transmitting and receiving apparatus in accordance with the present invention.

As illustrated in FIG. 4, the beam controller of the multi-beam transmitting and receiving apparatus in accordance with the present invention, for example, a reference numeral 120 of FIG. 2 or a reference numeral 220 of FIG. 3, includes a selecting unit 222 and a weight calculating unit 224. The selecting unit 222 generates a signal for selecting any one of a plurality of the beam forming units on the basis of the inputted time division information and the inputted platform location information, the time division information being the source allocation related information of the transmitting and receiving beam processing units. The weight calculating unit 224 serves to calculate a weight needed in renewing the beams and inputs the weight into the transmitting and receiving beam forming units.

First, in operation, if the information of the receiving beam which indicates an activation state of the subscribers of the service area, data amount and the like, and then if the time division information are inputted into the beam controller 120 or 220, the selecting unit of a beam forming unit 222 selects a suitable beam forming unit corresponding to the information. At this point, it is determined whether beams are formed or not in an area where additional allocation is required from the information of the receiving beam.

If the location change information of the platform is inputted into the beam controller 120 or 220, the weight calculating unit 224 renews a weight needed in each channel and then forwards it to the beam forming unit in order to form receiving or transmitting beams into a location desired by the platform.

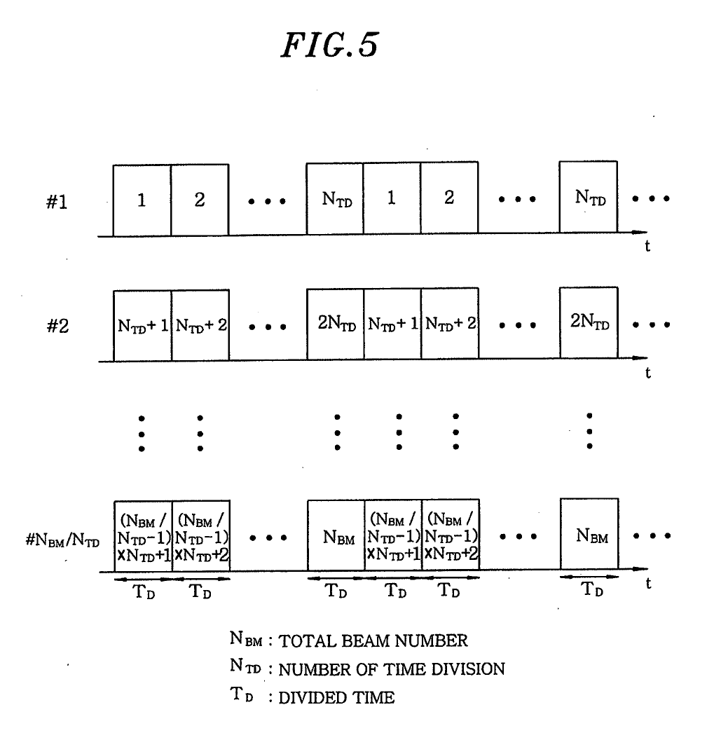

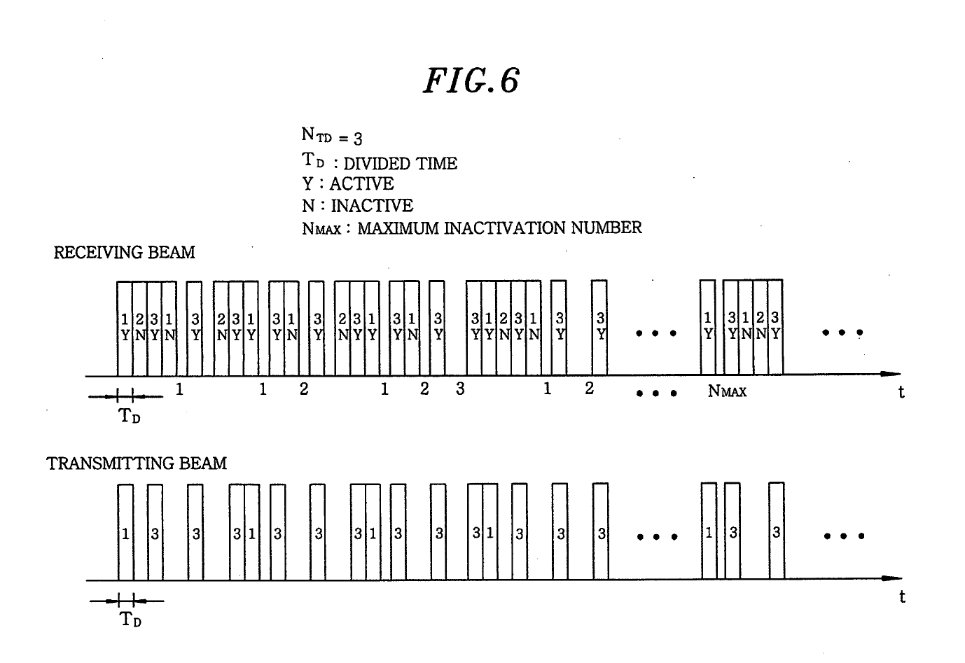

FIG. 5 presents a drawing for describing multiple beams formed by time-dividing the total beam number in the multi-beam transmitting and receiving apparatus in accordance with the present invention.

As described in FIG. 5, in beam forming units #1, 2 . . . #NBM/NTDB of the multi-beam transmitting and receiving apparatus of the present invention, a predetermined number, the total beam number NBM divided by the total number of the time division NTD, of multiple beams are formed at every time TD according to a time division method.

FIG. 6 represents a drawing for describing timely-divided multiple beams of an adaptive-type formed in the multi-beam transmitting and receiving apparatus in accordance with the present invention.

As illustrated in FIG. 6, the multi-beam transmitting and receiving apparatus of the present invention forms the transmitting and receiving beams capable of adapting to the activation state of the subscribers. For example, in case that the total number of the time division NTD is 3; and the divided time is TD, a first receiving beam indicates that the subscribers are alternately activated and inactivated with respect to the assigned time division; and a second receiving beam shows that the subscribers are inactivated to all the time division; and a third receiving beam shows that the subscribers are activated to all the time division.

In case of the first receiving beam, the beam forming unit of the multi-beam receiving apparatus of the present invention forms a beam at the assigned time division and then forms a receiving beam at the next beam forming time since the subscribers are in an active state. If the subscribers are in an inactive state, a beam of the next beam forming time is not generated at this point. However, since it is necessary to continuously detect whether the subscribers are activated or not, a receiving beam is again formed at the beam forming time after the next.

In case of the second receiving beam, since the subscribers are inactivated for all the time division, the beam forming unit increases the time when a beam is not formed step by step in order to efficiently form beams while detecting whether the subscribers are activated or not through the receiving beam. However, by defining a maximum inactivation number NMAX, this is performed within a range where service quality is not degraded. At first, it has one inactive period and then forms a receiving beam. After that, it has two inactive periods and then forms a receiving beam since the subscribers are in an inactive state. Further, the subscribers are still in an inactive state so it has tree sequential inactive periods. In this way, beam forming is performed until it reaches the defined maximum inactivation number NMAX as a limitation.

In case of the third receiving beam, the subscribers are in an active state for all the time division so that the beam forming unit continuously forms beams.

On the contrary, with respect to the transmitting beam, the beam forming unit of the multi-beam transmitting device of the present invention forms the transmitting beam only when the subscribers are detected to be activated.

While the invention has been shown and described with respect to the preferred embodiments, it will be understood by those skilled in the art that various changes and modifications may be made without departing from the spirit and scope of the invention as defined in the following claims.

1. A multi-beam transmitting apparatus in a wireless communication system, the apparatus comprising:
a plurality of transmitting beam forming units for forming timely-divided multiple beams, each of the timely-divided multiple beams having a period of a total number of time division NTD at every time TD when the beams are activated; and
a beam controller for controlling the transmitting beam forming units to select an arbitrary beam forming unit of a plurality of the transmitting beam forming units according to information about the time division,
wherein the number of the beam forming units is determined as the total number of the beams NBM divided by the number of time division NTD.

2. The multi-beam transmitting apparatus of claim 1, wherein the beam controller controls the transmitting beam forming units to select the beam forming unit according to information about an activation or inactivation state of subscribers in a service area of the wireless communication system.

3. The multi-beam transmitting apparatus of claim 2, wherein the transmitting apparatus forms transmitting beams of the transmitting beam forming unit as the timely-divided multiple beams by the control of the beam controller.

4. The multi-beam transmitting apparatus of claim 2, wherein the transmitting apparatus forms the beams of the transmitting beam forming units as adaptive-type timely-divided multiple beams which are temporarily activated or inactivated by control of the beam controller according to an activation or inactivation state of subscribers.

5. A multi-beam receiving apparatus in a wireless communication system, the device comprising:
a plurality of receiving beam forming units for forming timely-divided multiple beams, each of the timely-divided multiple beams having a period of time division NTD at every time TD when the beams are activated; and
a beam controller for controlling the receiving beam forming units to select an arbitrary beam forming unit of the receiving beam forming units according to information about the time division,
wherein the number of the beam forming units is determined as the total number of the beams NBM divided by the number of time division NTD.

6. The multi-beam receiving apparatus of claim 5, wherein the beam controller controls the receiving beam forming units to select the beam forming unit according to information about an activation or inactivation state of subscribers in a service area of the wireless communication system.

7. The multi-beam receiving apparatus of claim 6, wherein the receiving apparatus forms receiving beams of the receiving beam forming unit as the timely-divided multiple beams by the control of the beam controller.

8. The multi-beam receiving apparatus of claim 6, wherein the receiving apparatus forms the beams of the receiving beam forming units as adaptive-type timely-divided multiple beams which are temporarily activated or inactivated by control of the beam controller according to an activation or inactivation state of subscribers.

9. A multi-beam transmitting and receiving apparatus in a wireless communication system, the apparatus comprising:
a plurality of transmitting and receiving beam forming units for forming timely-divided multiple beams, each of the timely-divided multiple beams having a period of a total number of time division NTD at every time TD when the beams are activated; and
a beam controller for controlling the transmitting and receiving beam forming units to select an arbitrary beam forming unit of the transmitting and receiving beam forming units according to information about the time division,
wherein the number of the beam forming units is determined as the total number of the beams NBM divided by the number of time division NTD.

10. The multi-beam transmitting and receiving apparatus of claim 9, wherein the beam controller controls the transmitting and receiving beam forming units to select the beam forming unit according to information about an activation or inactivation state of subscribers in a service area of the wireless communication system.

11. The multi-beam transmitting and receiving apparatus of claim 10, wherein the transmitting and receiving apparatus forms both transmitting beams of the transmitting beam forming unit and receiving beams of the receiving beam forming unit as the timely-divided multiple beams by the control of the beam controller.

12. The multi-beam transmitting and receiving apparatus of claim 10, wherein the transmitting and receiving apparatus forms transmitting beams of the transmitting beam forming unit as adaptive-type timely-divided multiple beams which are temporarily activated or inactivated by control of the beam controller according to the activation or inactivation state of the subscribers and forms receiving beams of the receiving beam forming unit as the timely-divided multiple beams.

13. The multi-beam transmitting and receiving apparatus of claim 10, wherein the transmitting and receiving apparatus forms transmitting beams of the transmitting beam forming unit as the timely-divided multiple beams and forms receiving beams of the receiving beam forming unit as adaptive-type timely-divided multiple beams which are temporarily activated or inactivated.

14. The multi-beam transmitting and receiving apparatus of claim 10, wherein the transmitting and receiving apparatus forms the beams of the transmitting and receiving beam forming units as adaptive-type timely-divided multiple beams which are temporarily activated or inactivated by control of the beam controller according to an activation or inactivation state of subscribers.
